(19) United States
(12) Patent Application Publication
(10) Pub. No.: US 2009/0025325 A1
(43) Pub. Date: Jan. 29, 2009

(54) Two Color Crimped Style Thermal Barrier Design

(76) Inventors: David A. Gillespie, Kalamazoo, MI (US); Patrick M. Muessig, Paw Paw, MI (US)

Correspondence Address: FLYNN THIEL BOUTELL & TANIS, P.C., 2026 RAMBLING ROAD, KALAMAZOO, MI, 49008-1631, US

(21) Appl. No.: 11/887,985

(22) PCT Filed: Apr. 10, 2006
(86) PCT No.: PCT/US2006/013860

§ 371 Date: Oct. 5, 2007

Related U.S. Application Data
(60) Provisional application No. 60/672,752, filed on Apr. 19, 2005.

(51) Int. Cl. E06B 3/263; E04C 1/40; B23P 11/00

(52) U.S. Cl. 52/309.14; 29/897.312

(57) ABSTRACT

According to the invention, an architectural thermal barrier component and method of forming same includes an elongate section incorporating a thermal break, for example for use in the manufacture of window, door, skylight frame assemblies and other fenestration related assemblies. The method comprises forming multiple co-extensive elongate elements, one of which includes a channel portion, and aligning the elongate elements with one another by snap-fitting the elements together or sliding the elements together longitudinally. After the initial assembly, the method includes crimping the elements in engagement with one another, filling the channel with a settable liquid of low thermal conductivity, effecting solidification of the settable liquid to form a solidified thermal barrier element, and cutting longitudinally through or debridging any part of the elongate elements that bridges the thermal barrier element.

### FIELD OF THE INVENTION

The invention relates to the manufacture of thermal break sections for the use in the manufacture of window, door, skylight frame assemblies and other fenestration related assemblies.

### BACKGROUND OF THE INVENTION

Elongate metal sections for use in the manufacture of window and door frame assemblies are commonly extruded from aluminum. As is well known, it is often desirable for the interior and exterior parts of the section to be thermally isolated from one another. This thermal isolation prevents the low temperature of the exterior parts being transmitted to the interior parts and resulting in undesirable condensation on the internal surfaces. To this end it is common practice to provide a thermal break by connecting the interior and exterior parts of the section only by means of a nonmetallic connector of low thermal conductivity.

Following are two examples of methods used for providing such a thermal break. In a first method the section is formed from two separately preformed metal extrusions. These are connected together by preformed rigid non-metallic strips which are designed to interlock with the two metal extrusions respectively. Two non-metallic strips are often provided in spaced relation so as to form, with the metal extrusions, a hollow box section. There is then injected into this hollow box section a settable liquid plastics material, the setting of which forces the non-metallic strips and metal extrusions into rigid fixed relation.

A second common method of manufacturing a section with a thermal break is by the method known as “pour and cut”. According to this method the section is initially extruded and shaped to define an upwardly facing open channel. The channel is then filled with a settable liquid of low thermal conductivity, usually a plastics resin, which is then allowed to set. The part of the section forming the bottom of the channel is then cut through or debridged longitudinally, usually by a product from Azon USA, Inc. sold under the trademark “Bridgemill HMI”. If necessary, any other parts of the section connecting the interior and exterior parts thereof are also debridged so that the interior and exterior parts remain connected solely by the solidified resin, which thus provides the thermal break.

### SUMMARY OF THE INVENTION

According to the invention, an architectural thermal barrier component and method of forming same includes an elongate section incorporating a thermal break, for example for use in the manufacture of window or door frame assemblies. The method comprises forming multiple co-extensive elongate elements, one of which includes a channel portion, aligning the elongate elements with one another, crimping the elements in engagement with one another, filling the channel with a settable liquid of low thermal conductivity, effecting solidification of the settable liquid to form a solidified thermal barrier element, and cutting longitudinally through or debridging any part of the elongate elements that bridges the thermal barrier element.

### BRIEF DESCRIPTION OF THE DRAWINGS

The following is a more detailed description of an embodiment of the invention, by way of example, reference being made to the accompanying drawings in which:

FIG. 1 is a cross-sectional view of two metal extrusions according to the invention.

FIG. 1A is an enlarged cross-sectional view of a portion of the two metal extrusions according to FIG. 1.

FIG. 2 is a cross-sectional view of a port of the two metal extrusions of FIG. 1 in an engaged and unlocked condition.

FIG. 2A is an enlarged cross-sectional view of a portion of the two metal extrusions according to FIG. 2.

FIG. 3 is a cross-sectional view of the two metal extrusions of FIGS. 1-2 in an engaged and locked or crimped condition.

FIG. 3A is an enlarged cross-sectional view of a portion of the two metal extrusions according to FIG. 3.

FIG. 4 is a cross-sectional view of the two metal extrusions of FIGS. 1-3 after a settable resin has been placed.

FIG. 5 is a cross-sectional view of the two metal extrusions of FIGS. 1-4 after a portion of one of the metal extrusions has been cut away or debridged.

FIG. 6 is a cross-sectional view of metal extrusions for use in the method according to a further embodiment of the invention.

FIG. 7 is a cross-sectional view of the metal extrusions of FIG. 6 in an engaged and locked condition.

FIG. 8 is a cross-sectional view of the metal extrusions of FIGS. 6-7 after a settable resin has been placed and a portion of one of the extrusions has been cut away or debridged.

### DETAILED DESCRIPTION

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

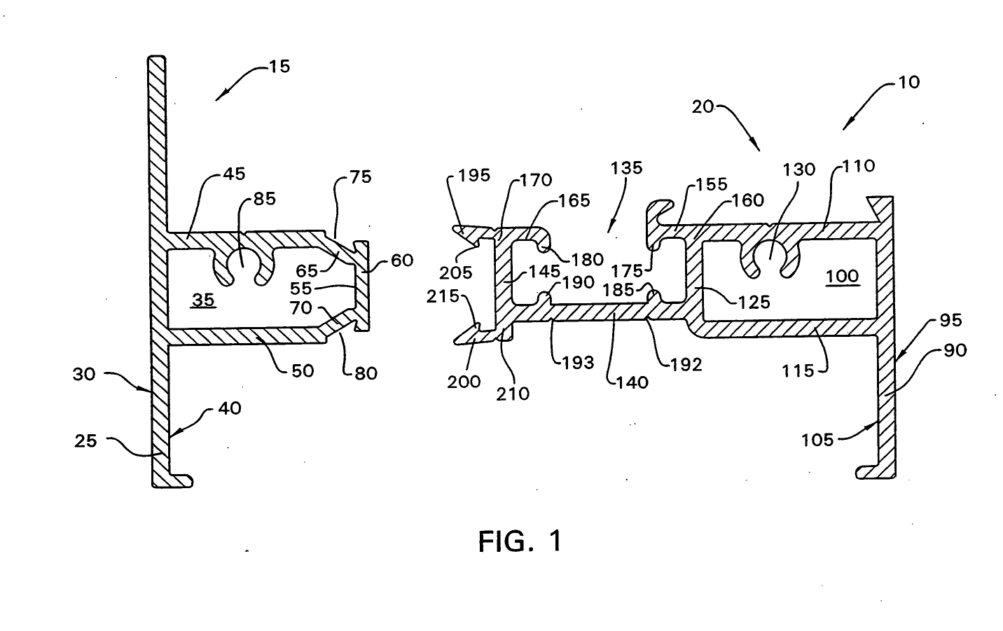

Referring to FIG. 1, an architectural thermal barrier component such as a window or door frame assembly 10 includes exterior and interior architectural elements 15, 20 extruded from a heat-conducting material, such aluminum or other metals. The elements 15, 20 are configured for assembly and receipt of a material with low thermal conductivity to form a thermal break in the window frame assembly 10.

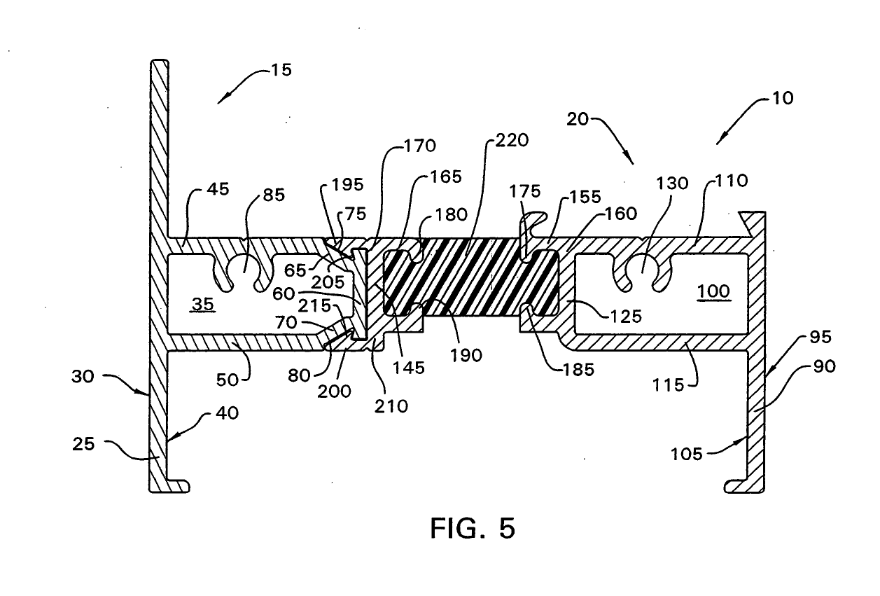

As shown in FIGS. 1-5, the exterior element 15 includes a planar portion 25 which has a flat outer surface 30 providing a visible exterior surface of the window frame assembly 10. A box construction 35 projects from an inner surface 40 of the planar portion 25 and includes an upper side 45 and a lower side 50. The upper and lower sides 45, 50 are joined at an inner end 55 of the box construction 35 by a transverse flange 60. The upper and lower sides 45, 50 taper inwardly toward each other at their inner ends 65, 70 so that respective upper and lower recesses 75, 80 are formed between the upper and lower sides 45, 50 and the transverse flange 60. The upper side 45 further includes an internal screw channel 85 to aid in assembling the window frame assembly 10, as is known in the art.

The interior element 20 includes a planar portion 90 which has a flat outer surface 95 providing a visible interior surface of the window frame assembly 10. A box construction 100 projects from an inner surface 105 of the planar portion 90 and includes an upper side 110 and a lower side 115. The upper and lower sides 110, 115 are joined at an inner end 120 of the box construction 100 by an inner side 125. The upper side 110 further includes an internal screw channel 130 to aid in assembling the window frame assembly 10, as is known in the art.

The interior element 20 further includes a channel portion 135 extending from the inner side 125 of the box construction 100. The channel portion 135 includes a channel floor section 140 extending inwardly, generally perpendicular to the inner side 125, proximate the lower side 115 of the box construction 100. A left channel side 145 extends upwardly from a left end 150 of the channel floor section 140. A flange 155 extends from an upper end 160 of the inner side 125, and a corresponding flange 165 extends from an upper end 170 of the left channel side 145. Each of the flanges 155, 165 includes a depending end portion 175, 180 respectively. Projections 185, 190 arise from the channel floor section 140, aligned with the depending end portions 175, 180. Guide notches 192, 193 are provided on a lower surface 194 of the channel floor section 140 inwardly of the projections 185, 190.

Upper and lower projections in the form of hooks 195, 200 extend from the left channel side 145. The upper hook 195 extends leftwardly from the upper end 170 of the left channel side 145, and includes an inwardly directed barb 205. The lower hook 200 extends leftwardly from a lower end 210 of the left channel side 145 and includes an inwardly directed barb 215.

### Method of Assembly

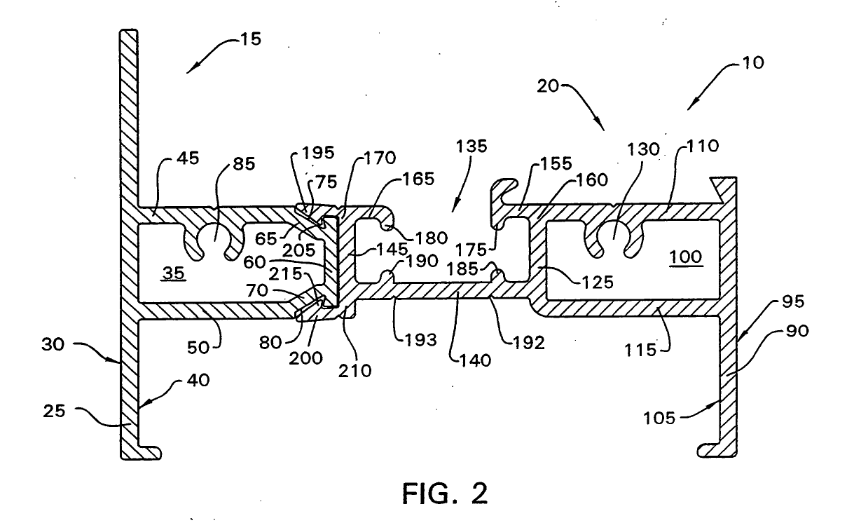

As shown in FIGS. 1 and 1A, the interior and exterior elements 15, 20 are positioned ready for, but prior to, assembly. In FIGS. 2 and 2A, the elements 15, 20 have been brought together such that the flange 60 is close against the left channel side 145. During the initial assembly necessary to reach the condition shown in FIGS. 2 and 2A, the flange 60 must pass between hooks 195, 200 or, more specifically, barbs 205, 215. The flange 60 is, however, wider than the distance between the barbs 205, 215.

One method of passing the flange 60 between the hooks 195, 200 is to move the elements 15, 20 laterally into engagement. As the elements 15, 20 move together, the hooks 195, 200 will contact the flange 60. As the flange 60 passes between the barbs 205, 215, the hooks 195, 200 will flex slightly until the barbs 205, 215 clear the flange 60. As the barbs 205, 215 clear the flange 60, there will be an audible and tactile “click” indicating to an assembler that the elements 15, 20 are in the initial assembled position.

Another method of passing the flange 60 between the hooks 195, 200 is to arrange the interior and exterior elements 15, 20 substantially end to end, aligning the hooks 195, 200 with the recesses 75, 80. The elements 15, 20 are then moved longitudinally to a side by side configuration as the hooks 195, 200 slide longitudinally into the recesses 75, 80.

Once assembled by either method, the upper hook 195 is aligned with the upper recess 75 and the lower hook 200 is aligned with the lower recess 80. The upper and lower hooks 195, 200 are splayed slightly outwardly from the recesses 75, 80 so that they are not firmly engaged within the recesses 75, 80. However, a sufficient portion of the upper and lower hooks 195, 200 are received into the recesses 75, 80 to effect a holding together of the exterior element 15 and the interior element 20 to enable the assembler to easily handle the loosely connected together parts during a furtherance of the processing and without the elements 15, 20 becoming easily disconnected. Since a two color scheme is to be employed, which color was applied to the exterior elements 15 and the interior elements 20 prior to the implementation of the loose connection therebetween, the thickness of the color coating on the exterior and interior elements 15, 20 will not impact or negate the loose connection described above.

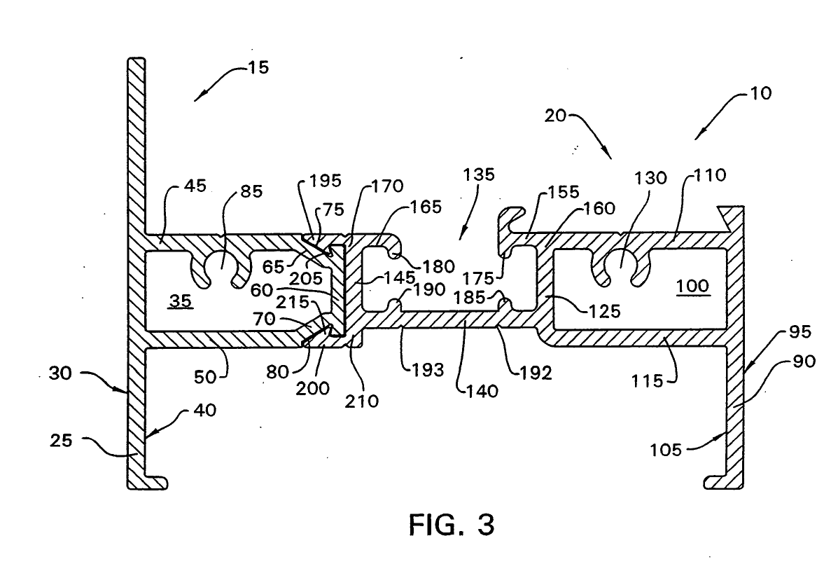

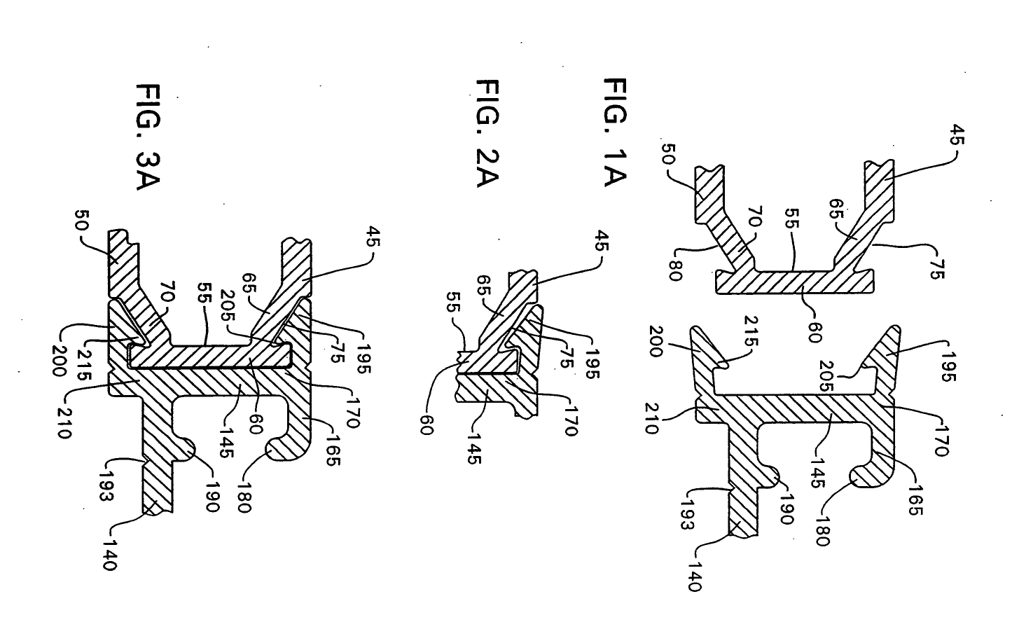

Referring to FIGS. 3 and 3A, the hooks 195, 200 have been locked or crimped into the recesses 75, 80. The interior element 20 is thereby locked onto the exterior element 15 by the hooks 195, 200 engaging the recesses 75, 80 and specifically the barbs 205, 215 engaging a back surface of the flange 60. This locking or crimping will effect the required fixed locking of the exterior and interior elements 15, 20 together so that the elements 15, 20 cannot move with respect to one another. This fixed locking will occur independent of the respective thicknesses of the color coating on the exterior and interior elements 15, 20. That is, the crimping will impart a plastic deformation of the material of the color coating so that a metal to metal connection will exist without the material of the color coating coming between the elements 15, 20 and negatively impacting the integrity or longevity of the connection.

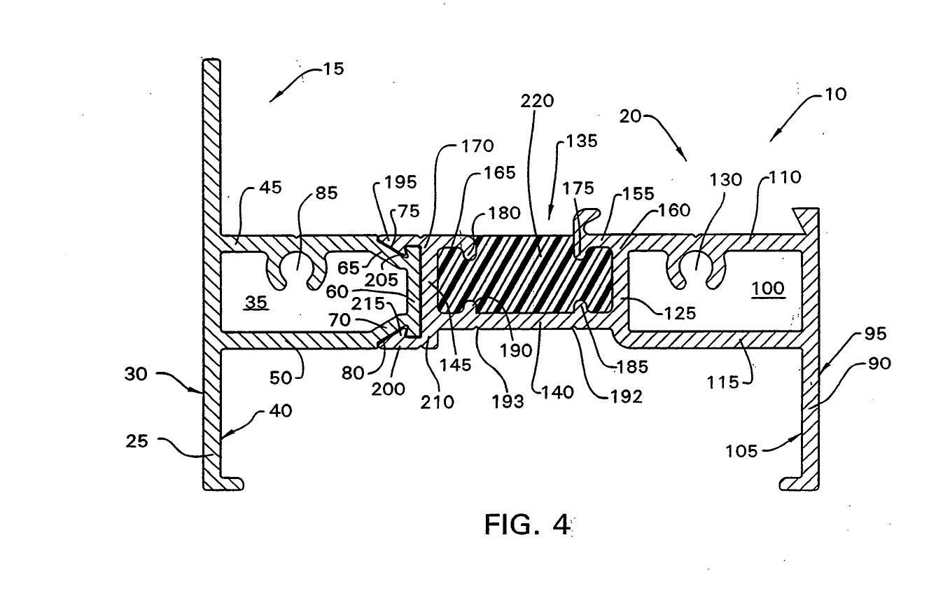

Referring to FIG. 4, the next step of forming the window or door frame assembly 10 is the application of a thermal barrier material 220, such as poured polyurethane or other plastic or composite material having a low thermal conductivity. Examples of such materials are the “su” (structural urethane) series of thermal barrier chemicals, produced by Azon USA, Inc. of Kalamazoo, Mich. In order to fill the channel portion 135, the combined section is fed into a conventional “pour and cut” machine (not shown). The construction and operation of such machines is well known and will not therefore be described in detail. The thermal barrier material 220 is applied to fill the channel portion 135. As the thermal barrier material 220 cures and solidifies, it is physically engaged by the depending end portions 175, 180 of the flanges 155, 165 and the projections 185, 190 of the channel floor section 140.

After the thermal barrier material 220 has cured, a circular saw or other cutting implement (not shown) integral in the “pour and cut” machine is traversed longitudinally of the assembly 10 so as to cut through or debridge the channel floor section 140 between the notches 192, 193 and between the projections 185, 190. The mechanical connection between the thermal barrier material 220 and the elements 15, 20 is thereby undisturbed as the projections 185, 190 remain intact and embedded in the thermal barrier material 220. The assembly 10 thereby remains mechanically connected, but the “debridging” of the channel floor section 140 creates a thermal break between the exterior and interior elements 15, 20. The only thermal connection between the elements 15, 20 is now through the thermal barrier material 220, which has low thermal conductivity.

### ALTERNATE EMBODIMENT

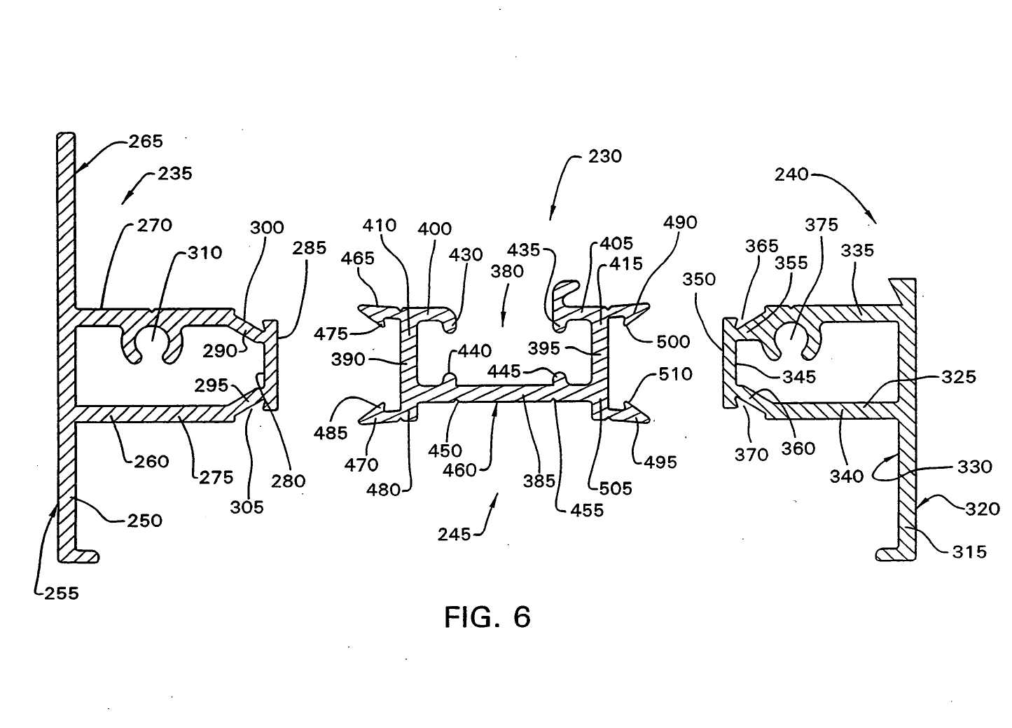

In a further embodiment of the invention, shown in FIGS. 6-8, a window frame assembly 230 for including a thermal break includes exterior and interior architectural elements 235, 240 and a connecting element 245. The exterior element 235 is formed in similar fashion to the exterior element 15 of the first embodiment above. The exterior element 235 includes a planar portion 250 which has a flat outer surface 255 providing a visible exterior surface of the window frame assembly 230. A box construction 260 projects from an inner surface 265 of the planar portion 250 and includes an upper side 270 and a lower side 275. The upper and lower sides 270, 275 are joined at an inner end 280 of the box construction 260 by a transverse flange 285. The upper and lower sides 270, 275 taper inwardly toward each other at their inner ends 290, 295 so that respective upper and lower recesses 300, 305 are formed between the upper and lower sides 270, 275 and the transverse flange 285. The upper side 270 further includes an internal screw channel 310 to aid in assembling the window frame assembly 230, as is known in the art.

The interior element 240 includes a planar portion 315 which has a flat outer surface 320 providing a visible interior surface of the window frame assembly 230. The remainder of the interior element 240 is formed similar to the exterior element 235. A box construction 325 projects from an inner surface 330 of the planar portion 315 and includes an upper side 335 and a lower side 340. The upper and lower sides 335, 340 are joined at an inner end 345 of the box construction 325 by a transverse flange 350. The upper and lower sides 335, 340 taper inwardly toward each other at their inner ends 355, 360 so that respective upper and lower recesses 365, 370 are formed between the upper and lower sides 335, 340 and the transverse flange 350. The upper side 335 further includes an internal screw channel 375 to aid in assembling the window frame assembly 230, as is known in the art.

The connecting element 245 includes a channel portion 380. The channel portion 380 is formed by a channel floor section 385 and a pair of opposing, upright left and right channel walls 390, 395. A flange 400, 405 extends inwardly from an upper end 410, 415 of each of the channel walls 390, 395. Each of the flanges 400, 405 includes a depending end portion 430, 435 respectively. Projections 440, 445 arise from the channel floor section 385, aligned with the depending end portions 430, 435. Guide notches 450, 455 are provided on a lower surface 460 of the channel floor section 385 inwardly of the projections 440, 445.

Upper and lower hooks 465, 470 extend outwardly from the left channel wall 390. The upper hook 465 extends outwardly from the upper end 410 of the left channel wall 390, and includes an inwardly directed barb 475. The lower hook 470 extends outwardly from a lower end 480 of the left channel wall 390 and includes an inwardly directed barb 485. In like manner, upper and lower hooks 490, 495 extend outwardly from the right channel wall 395. The upper hook 490 extends outwardly from the upper end 415 of the right channel wall 395, and includes an inwardly directed barb 500. The lower hook 495 extends outwardly from a lower end 505 of the right channel wall 395 and includes an inwardly directed barb 510.

In much the same fashion as the first embodiment, the window frame assembly 230 is assembled by drawing together the exterior and interior elements 235, 240. In the instant embodiment, however, the connecting element 245 is placed between the exterior and interior elements 235, 240 such that the flanges 285, 350 are close against the left and right channel walls 390, 395 respectively. The audible and tactile “click” will indicate to the assembler that each of the exterior and interior elements 235, 240 has engaged the connecting element 245. The elements 235, 240, 245 can also be initially assembled by longitudinal sliding, as in the first embodiment. In this arrangement, the upper hook 465 is aligned with the upper recess 300 of the exterior element 235 and the lower hook 470 is aligned with the lower recess 305 of the exterior element 235. Likewise, the upper hook 490 is aligned with the upper recess 365 of the interior element 240 and the lower hook 495 is aligned with the lower recess 370 of the interior element 240.

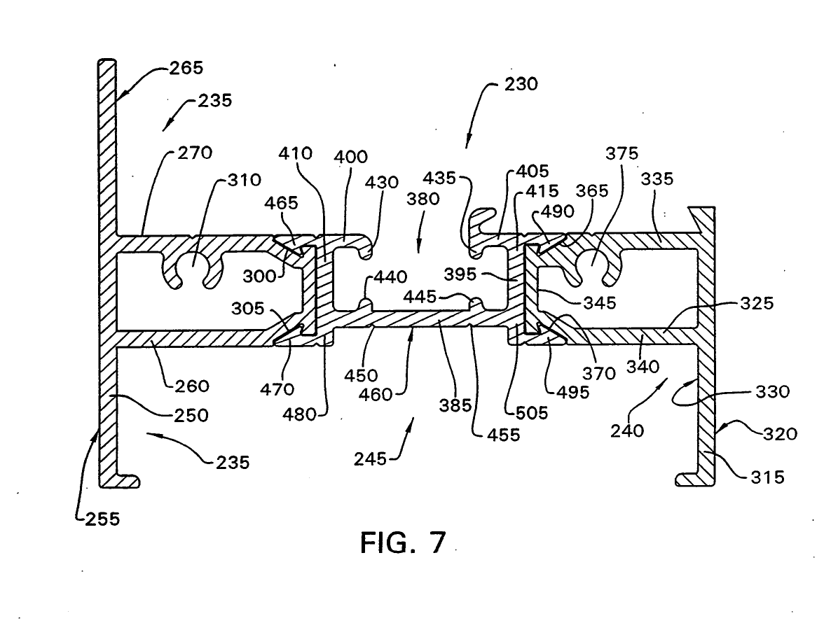

The upper and lower hooks 465, 470, 490, 495 are, however, splayed slightly outwardly from the recesses 300, 305, 365, 370 so that they are not firmly engaged. As in the above embodiment, the hooks 465, 470, 490, 495 are locked or crimped into the recesses 300, 305, 365, 370 to lock the exterior and interior elements 235, 240 onto the connecting element 245, as shown in FIG. 7.

The next step of forming the window or door frame assembly 230 with thermal break section is the application of a thermal barrier material 515 such as poured polyurethane or other plastic or composite material having a low thermal conductivity. The combined section is fed into a conventional “pour and cut” machine (not shown). The construction and operation of such machines is well known and will not therefore be described in detail. The thermal barrier material 515 is applied to fill the channel portion 380. As the thermal barrier material 515 cures and solidifies, it is physically engaged by the depending end portions 430, 435 of the flanges 400, 405 and the projections 440, 445 of the channel floor section 385.

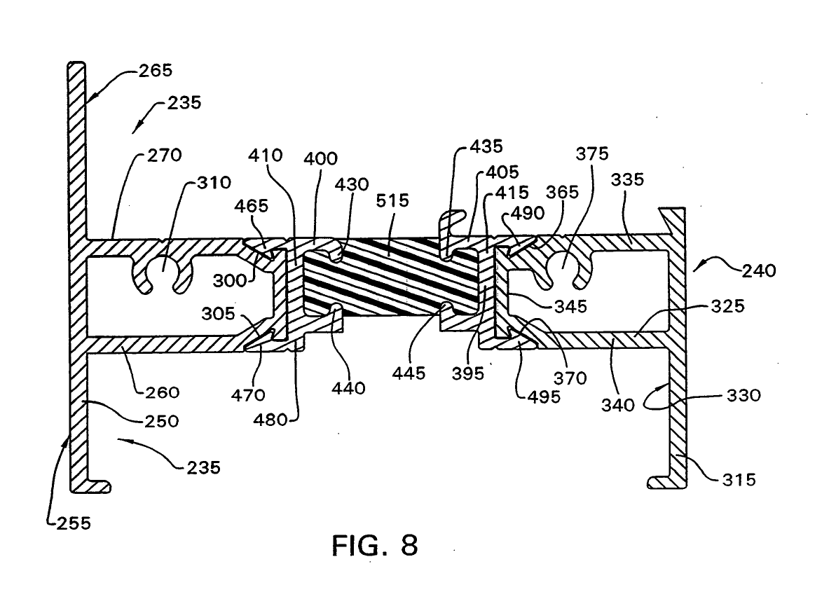

After the thermal barrier material 515 has cured, a circular saw or other cutting implement (not shown) integral in the “pour and cut” machine is traversed longitudinally of the assembly 230 so as to cut through or debridge the channel floor section 385 between the notches 450, 455 and between the projections 440, 445. The mechanical connection between the thermal barrier material 515 and the separated left and right walls 390, 395 of the channel portion 380 is thereby undisturbed as the projections 440, 445 remain intact and embedded in the thermal barrier material 515, as shown in FIG. 8. The assembly 230 thereby remains mechanically connected, but the “debridging” of the channel floor section 385 creates a thermal break between the exterior and interior elements 235, 240. The only thermal connection between the elements 235, 240 is now through the thermal barrier material 515, which has low thermal conductivity.

The arrangements described above have the advantage that the elements 15, 20, 235, 240 can be extruded consistently with the required tolerances using conventional extrusion technology. The “pour and cut” apparatus can have a conventional configuration and can be used in the conventional manner when the combined section has been assembled.

The pre-coloring of the elements may be carried out by any of the commonly used methods. The detailed dimensions of the inter-engaging parts of the elements may be so selected as to allow for the thickness of the colored coating and the lesser hardness of the coating may be employed to compensate for tolerances in the dimensions of the inter-engaging parts.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the scope of the appended claims.

1-12. (canceled)

13. A method of making an architectural thermal barrier component, comprising the steps of:
fabricating an elongate first heat-conductive part having spaced first and second projections which project outwardly in substantially the same direction transversely of said first heat-conductive part;
fabricating an elongate second heat-conductive part having a flange which projects outwardly in a direction transversely of said second heat-conductive part;
one of said first and second heat-conductive parts including walls defining a lengthwise extending channel that is isolated from the other of said first and second heat-conductive parts;
orienting said first and second heat-conductive parts so that said first and second projections on said first heat-conductive part extend toward said second heat-conductive part and said flange on said second heat-conductive part extends toward said projections on said first heat-conductive part;
moving said heat-conductive parts toward each other until said flange moves into the region between said first and second projections;
crimping said first and second projections into fixed engagement with said second heat-conductive part;
applying to said channel in one of said first and second heat-conductive parts a thermal barrier material which extends lengthwise thereof; and
machining away a central portion of one of said walls defining said channel in said one of said first and second heat-conductive parts at a location between the ends thereof.

14. The method of claim 13, wherein said step of fabricating said first heat-conductive part further includes the step of imparting to said first heat-conductive part a first color coating and wherein said step of fabricating said second heat-conductive part further includes the step of imparting to said second heat-conductive part a second color coating different from said first color coating.

15. The method of claim 14, wherein said step of crimping of said first and second projections imparts a plastic deformation of at least one of the first color coating and the second color coating for compensating for tolerance variations between the inter-connected first and second heat-conducting parts and for effecting a metal to metal connection between the first and second heat-conductive parts without the first or second color coating interfering with the integrity of the fixed engagement therebetween.

16. The method of claim 13, wherein the step of fabricating said first heat-conductive part further includes providing said first heat-conductive part with spaced third and fourth projections which project outwardly in substantially the same direction transversely of said first heat-conductive part, the method further comprising the steps of:
fabricating an elongate third heat-conductive part having a flange which projects outwardly in a direction transversely of said third heat-conductive part;
orienting said first and third heat-conductive parts so that said third and fourth projections on said first heat-conductive part extend toward said third heat-conductive part and said flange on said third heat-conductive part extends toward said third and fourth projections on said first heat-conductive part;
moving said first and third heat-conductive parts toward each other until said flange of said third heat-conductive part moves into the region between said third and fourth projections; and
crimping said third and fourth projections into fixed engagement with said third heat-conductive part.

17. The method according to claim 13, wherein said step of fabricating said first heat-conductive part includes the step of forming said first and second projections to extend lengthwise of said first heat-conductive part substantially parallel to each other, and wherein said machining step is carried out by machining through said wall of said first heat-conductive part a slot extending lengthwise of said first heat-conductive parts.

18. A method of making an architectural thermal barrier component, comprising the steps of:
fabricating an elongate first heat-conductive part having spaced first and second projections which project outwardly in substantially the same direction transversely of said first heat-conductive part and having spaced third and fourth projections which project outwardly in substantially the same direction transversely of said first heat-conductive part;
fabricating an elongate second heat-conductive part having a flange which projects outwardly in a direction transversely of said second heat-conductive part, said second heat-conductive part having thereon first and second surface portions which are disposed on opposite sides of said flange and which face in the direction in which said flange projects outwardly from said second heat-conductive part;
fabricating an elongate third heat-conductive part having a flange which projects outwardly in a direction transversely of said third heat-conductive part, said third heat-conductive part having thereon first and second surface portions which are disposed on opposite sides of said flange and which face in the direction in which said flange projects outwardly from said third heat-conductive part;
orienting said heat-conductive parts so that said first and second projections on said first heat-conductive part extend toward said second heat-conductive part and said flange on said second heat-conductive part extends towards said first and second projections on said first heat-conductive part, and said third and fourth projections on said first heat-conductive part extend toward said third heat-conductive part and said flange on said third heat-conductive part extends towards said third and fourth projections on said first heat-conductive part;
moving said heat-conductive parts toward each other until said flange of said second heat-conductive part moves into the region between said first and second projections and said flange of said third heat-conductive part moves into the region between said third and fourth projections;
crimping said first and second projections into fixed engagement with said flange of said second heat-conductive part and said third and fourth projections into fixed engagement with said flange of said third heat-conductive part;
applying to said first heat-conductive part a thermal barrier material which extends lengthwise thereof; and
machining away a central portion of said first heat-conductive part at a location between the ends thereof.

19. A method according to claim 18, wherein said first heat-conductive part includes walls defining a lengthwise extending channel that is isolated from the other of said heat-conductive parts and said machining occurs to a central portion of a wall defining said channel.

20. A method of making an architectural thermal barrier component, comprising the steps of:
fabricating elongate first and second architectural elements, one of said first and second architectural elements having spaced first and second projections which project outwardly in substantially the same direction transversely of said one architectural element, the other of said first and second architectural elements having spaced retainers, and one of said first and second architectural elements including walls defining a lengthwise extending channel that is isolated from the other of said first and second architectural elements;
orienting said first and second architectural elements so that said first and second projections extend toward said spaced retainers;
moving said first and second architectural elements toward each other until said first and second projections move into alignment with said spaced retainers;
crimping said first and second projections into fixed engagement with said spaced retainers;
applying a thermal barrier material to said channel portion; and
machining away a central portion of said channel portion of one of said walls defining said channel in said one of said first and second architectural elements at a location between the ends thereof.

21. A method of making an architectural thermal barrier component, comprising the steps of:
fabricating elongate first and second architectural elements each having spaced first and second retaining portions thereon;
fabricating an elongate connecting element having a thermal barrier channel having a channel floor and channel walls, and projections which extend outwardly in a direction transversely of said connecting element;
orienting said first and second architectural elements with said connecting element so that said first and second retaining portions on each of said first and second architectural elements extend toward said connecting element and said projections on said connecting element extend toward said first and second architectural elements in alignment with said retaining portions;
crimping said first and second projections into fixed engagement with said spaced retainers;
applying a thermal barrier material to said thermal barrier channel; and
machining away a central portion of said channel floor between said channel walls.

22. An architectural thermal barrier component, comprising:
an elongate first heat-conductive part having spaced first and second projections which project outwardly in substantially the same direction transversely of said first heat-conductive part;
an elongate second heat-conductive part having a flange which projects outwardly in a direction transversely of said second heat-conductive part;
one of said first and second heat-conductive parts including walls defining a lengthwise extending channel that is isolated from the other of said first and second heat-conductive parts, one of said walls being cut-away;
whereby said first and second heat-conductive parts are configured so that when oriented for assembly, said first and second projections on said first heat-conductive part extend toward said second heat-conductive part and said flange on said second heat-conductive part extends towards said projections on said first heat-conductive part, said flange being wider than a distance between said projections, said projections each including an inwardly directed hook portion configured to contact said flange in passing during initial assembly to serve as an audible and tactile indicator to an assembler that the parts are properly positioned, the first and second projections further being configured to be crimped into fixed engagement with the flange after initial assembly, fixing the first and second head-conductive parts together; and
a thermal barrier material received in said channel and extending lengthwise of said one of the first and second heat-conductive parts and bridging said first and second heat-conductive parts together to thereby form a thermal break in the architectural thermal barrier component.

23. An architectural thermal barrier component, comprising:
an elongate first heat-conductive part having spaced first and second projections which project outwardly in substantially the same direction transversely of said first heat-conductive part and having spaced third and fourth projections which project outwardly in substantially the same direction transversely of said first heat-conductive part;
an elongate second heat-conductive part having a flange which projects outwardly in a direction transversely of said second heat-conductive part, said second heat-conductive part having thereon first and second surface portions which are disposed on opposite sides of said flange and which face in the direction in which said flange projects outwardly from said second heat-conductive part;
an elongate third heat-conductive part having a flange which projects outwardly in a direction transversely of said third heat-conductive part, said third heat-conductive part having thereon first and second surface portions which are disposed on opposite sides of said flange and which face in the direction in which said flange projects outwardly from said third heat-conductive part;
said heat-conductive parts being configured so that said first and second projections on said first heat-conductive part extend toward said second heat-conductive part and said flange on said second heat-conductive part extends towards said first and second projections on said first heat-conductive part, and said third and fourth projections on said first heat-conductive part extend toward said third heat-conductive part and said flange on said third heat-conductive part extends towards said third and fourth projections on said first heat-conductive part, the flanges each being wider than the clearance between the respective first and second projections or third and fourth projections, whereby moving said heat-conductive parts toward each other until said flange of said second heat-conductive part moves into the region between said first and second projections and said flange of said third heat-conductive part moves into the region between said third and fourth projections results in a tactile or audible signal to the assembler that the heat-conductive parts are engaged, said first and second projections being configured for crimping into fixed engagement with said flange of said second heat-conductive part and said third and fourth projections being configured for crimping into fixed engagement with said flange of said third heat-conductive part; and
a thermal barrier material that extends lengthwise of at least one of said first, second and third heat-conductive parts, said at least one heat-conductive part having a cut-away portion bridged by the thermal barrier material to thereby form a thermal break in the architectural thermal barrier component.

24. An architectural thermal barrier component according to claim 23, wherein said first heat-conductive part includes walls defining a lengthwise extending channel that is isolated from the other of said heat-conductive parts, one of the walls defining said channel being cut-away so that said thermal barrier material connectively bridges said first and second heat-conductive parts together to thereby form a thermal break in the architectural thermal barrier component.

25. An architectural thermal barrier component, comprising:
an elongate first heat-conductive part having spaced first and second projections which project outwardly in substantially the same direction transversely of said first heat-conductive part;
an elongate second heat-conductive part having a flange which projects outwardly in a direction transversely of said second heat-conductive part;
one of said first and second heat-conductive parts including walls defining a lengthwise extending channel that is isolated from the other of said first and second heat-conductive parts, one of said walls being cut-away;
whereby said first and second heat-conductive parts are configured so that when oriented for assembly, said first and second projections on said first heat-conductive part extend toward said second heat-conductive part and said flange on said second heat-conductive part extends towards said first and second projections on said first heat-conductive part, said flange being wider than a distance between said projections, the projections further being configured to be crimped into fixed engagement with the flange after initial assembly, fixing the first and second head-conductive parts together; and
a thermal barrier material received in said channel and extending lengthwise of said one of the first and second heat conductive parts and bridging said first and second heat conductive parts together to thereby form a thermal break in the architectural thermal barrier component.

26. The architectural thermal barrier component according to claim 25, further comprising said first and second projections each including an inwardly directed hook portion configured to contact said flange in passing during initial assembly to serve as an audible and tactile indicator to an assembler that the parts are properly positioned.
